(19) United States
(12) Patent Application Publication
(10) Pub. No.: US 2024/0114454 A1
(43) Pub. Date: Apr. 4, 2024

(54) Method And Apparatus For Low Power Wake-Up Signal Design

(71) Applicant: MediaTek Inc., Hsinchu City (TW)

(72) Inventors: Chien-Chun Cheng, Hsinchu City (TW); Wei-De Wu, Hsinchu City (TW); Yi-Ju Liao, Hsinchu City (TW)

(21) Appl. No.: 18/236,685

(22) Filed: Aug. 22, 2023

Related U.S. Application Data
(60) Provisional application No. 63/377,742, filed on Sep. 30, 2022.

(51) Int. Cl. H04W 52/02

(52) U.S. Cl. CPC H04W 52/0235

(57) ABSTRACT

Various solutions for low-power wake-up signal (LP-WUS) design with respect to user equipment and network node in mobile communications are described. An apparatus may receive a LP-WUS configuration from a network node. The apparatus may receive a LP-WUS based on the LP-WUS configuration from the network node. The apparatus may determine whether to wake up according to the LP-WUS. The LP-WUS with N subcarriers (SCs) is generated through a transformation of M-bit on-off keying (OOK) in a time domain. The transformation is a discrete Fourier transform (DFT) or least square operation. K samples are generated from the M bits with a signal modification or a signal truncation. The LP-WUS is generated through an inverse fast Fourier transform (IFFT) operation. The K is a size of the IFFT operation of cyclic-prefix orthogonal frequency-division multiple access (CP-OFDMA). The N is less than or equal to the K.

### CROSS REFERENCE TO RELATED PATENT APPLICATION(S)

The present disclosure is part of a non-provisional application claiming the priority benefit of U.S. Patent Application No. 63/377,742, filed 30 Sep. 2022, the content of which herein being incorporated by reference in its entirety.

### TECHNICAL FIELD

The present disclosure is generally related to mobile communications and, more particularly, to low power wake-up signal (LP-WUS) design with respect to user equipment (UE) and network apparatus in mobile communications.

### BACKGROUND

Unless otherwise indicated herein, approaches described in this section are not prior art to the claims listed below and are not admitted as prior art by inclusion in this section.

The 5^{th}-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Therefore, it is important to achieve 5G network power savings. There are many conflicts among performance metrics. Quality of service (QoS) and power savings may need a tradeoff. Some local optimal solutions may not achieve the global/overall optimum. For example, the wake-up signal (WUS) saving user equipment (UE) power by 20% may degrade 30% of base station (BS) power savings.

Accordingly, how to design the low power WUS (LP-WUS) for better energy saving becomes an important issue for the newly developed wireless communication network. Therefore, there is a need to provide proper schemes and designs for the LP-WUS in response to the energy saving requirements.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to LP-WUS design in mobile communications. It is believed that the above-described issue would be avoided or otherwise alleviated by implementing one or more of the proposed schemes described herein.

In one aspect, a method may involve a network node performing a transformation of M-bit on-off keying (OOK) in a time domain to generate a low-power wake-up signal (LP-WUS) with N subcarriers (SCs). The transformation is a discrete Fourier transform (DFT) or a least square operation. K samples are generated from the M bits with a signal modification or a signal truncation. The method may also involve the network node performing an inverse fast Fourier transform (IFFT) operation for the LP-WUS. The K is a size of the IFFT operation of cyclic-prefix orthogonal frequency-division multiple access (CP-OFDMA). The N is less than or equal to the K. The method may further involve the network node transmitting an LP-WUS configuration to a user equipment (UE). The method may further involve the network node transmitting the LP-WUS based on the WUS configuration to the UE.

In another aspect, an apparatus may involve a transceiver which, during operation, wirelessly communicates with at least one UE. The apparatus may also involve a processor communicatively coupled to the transceiver. The processor may perform a transformation of M-bit OOK in a time domain to generate a LP-WUS with N SCs. The transformation is a DFT or a least square operation. K samples are generated from the M bits with a signal modification or a signal truncation. The processor may also perform an IFFT operation for the LP-WUS. The K is a size of the IFFT operation of CP-OFDMA. The N is less than or equal to the K. The processor may further transmit, via the transceiver, a LP-WUS configuration to the UE. The processor may further transmit, via the transceiver, the LP-WUS based on the WUS configuration to the UE.

In another aspect, a method may involve an apparatus receiving a LP-WUS configuration from a network node. The method may also involve the apparatus receiving a LP-WUS based on the LP-WUS configuration from the network node. The method may also involve the apparatus determining whether to wake up according to the LP-WUS. The LP-WUS with N SCs may be generated through a transformation of M-bit OOK in a time domain. The transformation is a DFT or a least square operation. K samples are generated from the M bits with a signal modification or a signal truncation. In addition, the LP-WUS may be generated through an IFFT operation for the LP-WUS. The K is a size of the IFFT operation of CP-OFDMA. The N is less than or equal to the K.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of an orthogonal frequency-division multiplexing (OFDM)-based multicarrier on-off keying (MC-OOK) system under schemes in accordance with implementations of the present disclosure.

FIG. 2 is a diagram depicting an example scenario of an LP-WUS deployment under schemes in accordance with implementations of the present disclosure.

FIG. 3 is a diagram depicting an example scenario of a Manchester OOK encoding under schemes in accordance with implementations of the present disclosure.

FIG. 4 is a diagram depicting another example scenario of a resource element (RE) mapping under schemes in accordance with implementations of the present disclosure.

FIG. 5 is a diagram depicting another example scenario of a waveform shaping under schemes in accordance with implementations of the present disclosure.

FIG. 6 is a diagram depicting another example scenario of an OFDM symbol with Manchester OOK bits under schemes in accordance with implementations of the present disclosure.

FIG. 7 is a diagram depicting another example scenario of a cyclic prefix (CP) adding under schemes in accordance with implementations of the present disclosure.

FIG. 8 is a diagram depicting another example scenario of a CP configuration under schemes in accordance with implementations of the present disclosure.

FIG. 9 is a diagram depicting another example scenario of a masking OOK under schemes in accordance with implementations of the present disclosure.

FIG. 10 is a block diagram of an example communication system in accordance with an implementation of the present disclosure.

FIG. 11 is a flowchart of an example process in accordance with an implementation of the present disclosure.

FIG. 12 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to low-power wake-up signal (LP-WUS) design for energy saving in mobile communications. According to the present disclosure, a number of possible solutions may be implemented separately or jointly. That is, although these possible solutions may be described below separately, two or more of these possible solutions may be implemented in one combination or another.

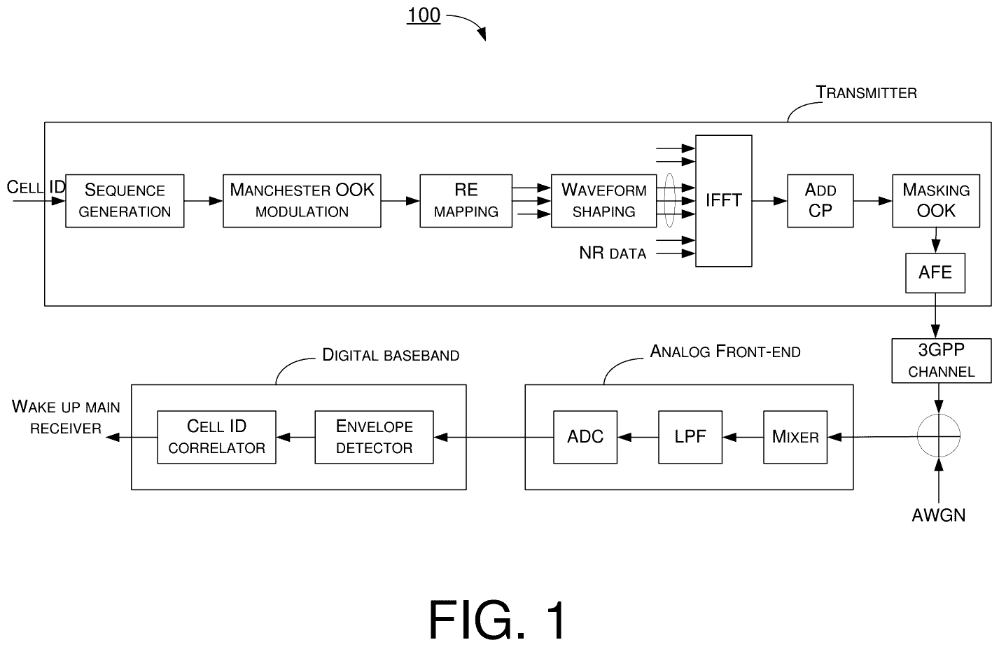

FIG. 1 illustrates an example scenario 100 for an orthogonal frequency-division multiplexing (OFDM)-based multicarrier on-off keying (MC-OOK) system under schemes in accordance with implementations of the present disclosure. Scenario 100 involves a network node (e.g., a macro base station and multiple micro base stations) and a UE, which may be a part of a wireless communication network (e.g., an LTE network, a 5G/NR network, an IoT network or a 6G network). Referring to FIG. 1, a transmitter (i.e., the transmitter of the OFDM-based MC-OOK system) may comprise a plurality of function modules or circuits for a sequence generation, a Manchester OOK modulation, a resource element (RE) mapping operation, a waveform shaping operation, a an inverse fast Fourier transform (IFFT) operation, adding cyclic prefix (CP) operation, a masking OOK operation, and an analog front end (AFE). The transmitter may transmit the signals to the UE through a channel specified in 3rd Generation Partnership Project (3GPP) with Additive white Gaussian noise (AWGN). A receiver (i.e., the receiver of the OFDM-based MC-OOK system) may comprise an AFE, a digital baseband, a low-power wake-up radio (LP-WUR) and a main radio (or main receiver). The AFE of the receiver may comprise a mixer, a low-pass filter (LPF) and an analog-to-digital convertor (ADC). The digital baseband of the receiver may comprise an envelope detector (ED) and a cell identity (ID) correlator. Details for each element in FIG. 1 are discussed below.

In some implementations, in the OFDM-based MC-OOK system, the network node may perform a multi-carrier amplitude shift-keying (MC-ASK) waveform generation with encoded bits to generate a low-power wake-up signal (LP-WUS). For example, the network node may perform a transformation of M-bit OOK in the time domain to generate a LP-WUS with N subcarriers (SCs). The transformation may be a discrete Fourier transform (DFT) or least square operation, and K samples are generated from M bits with the signal modification and/or signal truncation. In addition, the network node may perform an IFFT operation for the LP-WUS. The parameter K may be a size of the IFFT operation of cyclic-prefix orthogonal frequency-division multiple access (CP-OFDMA), and the parameter N may be less than or equal to the parameter K. The plurality of SCs may comprise a plurality of guard bands. The network node may transmit an LP-WUS configuration to the UE and transmit the LP-WUS to the UE based on the WUS configuration.

In some implementations, the MC-ASK waveform generation may comprise an OOK modulation (e.g., Manchester OOK modulation). A single-bit OOK may be used in one OFDM symbol, and the N SCs of the LP-WUS may be modulated based on the OOK values. In an event that the OOK value corresponds to a first value (e.g., 1), the N SCs may be modulated, and in an event that the OOK value corresponds to a second value (e.g., 0), the N SCs may be zero power from a baseband point of view.

In some implementations, the LP-WUS may contain one or more sequences for detecting or selecting the LP-WUS. The one or more sequences may be determined based on a sequence detection or a sequence selection, or based on the encoded bits. The one or more sequences may be associated with at least one of a configurable sequence type, an encoding scheme and additional bits (e.g., a cyclic redundancy check (CRC) code and a frame check sequence (FCS) code). The encoded bits may comprise at least one of a CRC code and a FCS code. In an example, the UE may receive WUR frames with CRC code.

In some implementations, the LP-WUS configuration may comprise a monitoring configuration for an LP-WUR. In an example, the monitoring configuration may comprise an on-off switch of the LP-WUR corresponding to a duty cycle. In another example, the monitoring configuration may comprise a continuous monitoring in which the LP-WUR is on.

In some implementations, the LP-WUS may associate with at least one of a UE group ID, a UE ID, a cell ID, cell information, time information, system information (SI) change information, tracking area information, radio access network (RAN) information, system frame number (SFN) information, a WUR ID and a WUR group ID.

The LP-WUR may be operated around the direct current (DC) (i.e., a central frequency) to apply a simple envelope detector (ED). The LP-WUS may be limited per frequency band or cell settings.

The cell ID may be carried by LP-WUS. The cell ID can prevent being woken up by another cell. In the NR, 1008 physical cell identities (PCI) may be carried by 127 binary phase-shift keying (BPSK) symbols of primary synchronization signal (PSS) and 127 BPSK symbols of secondary synchronization signal (SSS). In order to handle overhead, the LP-WUS may carry partial cell ID information (e.g., only SSS) and the main radio may share the partial cell ID information to identify the PCI.

The UE group ID within a cell can prevent waking up all UE in the cell. The LP-WUR may wake the main radio if a target cell ID and a UE group ID are detected. The UE grouping can be in a time division duplexing (TDD) manner if the time stamps (e.g., SFN) are provided by network node.

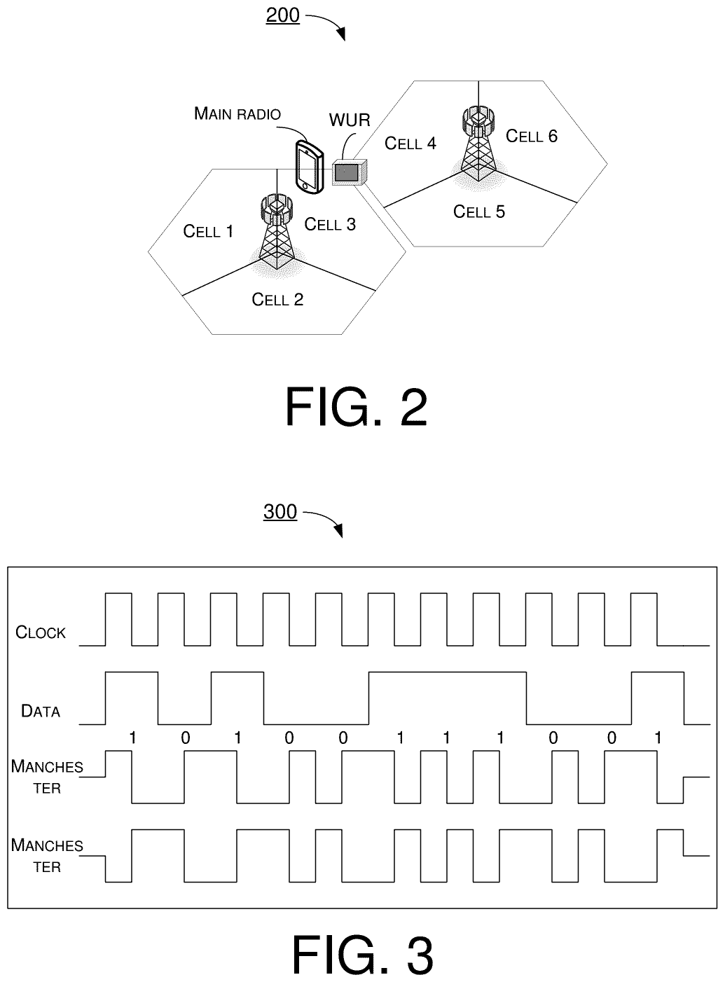

FIG. 2 illustrates an example scenario 200 for an LP-WUS deployment under schemes in accordance with implementations of the present disclosure. Scenario 200 involves a plurality of network nodes (e.g., a macro base station and multiple micro base stations) and a UE, which may be a part of a wireless communication network (e.g., an LTE network, a 5G/NR network, an IoT network or a 6G network). Referring to FIG. 2, the WUS #1 may carry the cell ID of the cell 1, and the WUS #5 may carry the cell ID of the cell 5.

In some implementations, in the function module or circuit for the sequence generation, the sequence may reuse the PSS sequence (e.g., NR PSS sequence) or the SSS sequence (e.g., NR SSS sequence). The PSS and SSS may contain partial cell ID information and may be extended to carry more information bits by a cover code using another sequence, such as a 127-length Gold sequence. The PSS may have better auto-correlation. Therefore, the PSS may be better used as a preamble for synchronization. In addition, the SSS may have better cross-correlation. Therefore, the SSS may be better used as a payload for information.

In some implementations, in the function module or circuit for the Manchester OOK modulation, the Manchester coding may be used to generate an average DC level of 50%. The average DC may be suitable for the circuit design and managing the transmitted radio frequency (RF) spectrum after modulation. The average power may be a constant and independent of the data which is encoded.

The OOK demodulation may require estimating the signal-noise ratio (SNR) for an optimal threshold, which is complex to LP-WUR. The Manchester encoding can simplify the demodulation by comparing the two received signals. If the previous received signal is higher than the current received signal, the UE may decode as 1. Otherwise (i.e., the previous received signal is lower than the current received signal), the UE may decode as 0.

The Manchester decoding may require a start timing of the signal. The UE may obtain the start timing if the network node sends the LP-WUS which includes a preamble and a payload to the UE. The preamble may not have the Manchester encoding, but may use a known sequence between the UE and network node. The payload may have the Manchester encoding to simplify the demodulation process. In another example, the UE may obtain the start timing from the main radio. The main radio may provide a coarse timing before the main radio is powered off.

The Manchester encoding may be used as a repetition code. The network node may provide the Manchester coding information to the main radio via a signaling, e.g., via a system information block (SIB), a radio resource control (RRC), a medium access control control-element (MAC CE), or downlink control information (DCI). The Manchester coding information may comprise a coding rate, enable or disable, or types.

FIG. 3 illustrates an example scenario 300 for a Manchester OOK encoding under schemes in accordance with implementations of the present disclosure. Scenario 300 involves a network node (e.g., a macro base station and multiple micro base stations) and a UE, which may be a part of a wireless communication network (e.g., an LTE network, a 5G/NR network, an IoT network or a 6G network). Referring to FIG. 3, according to the G.E. Thomas convention, in the Manchester coding, bit “0” is defined as the signal level is from low to high, and bit “1” is defined as the signal level is from high to low. In addition, according to the IEEE 802.3 convention, in the Manchester coding, bit “1” is defined as the signal level is from low to high, and bit “0” is defined as the signal level is from high to low.

In some implementations, in the function module or circuit for the RE mapping operation, the network node may map the coded LP-WUS sequence into the REs, from the low subcarriers to the high subcarriers or around. The LP-WUS sequence may use REs which are near the DC carrier. In addition, the guard bands may be on both sides of the LP-WUS sequence.

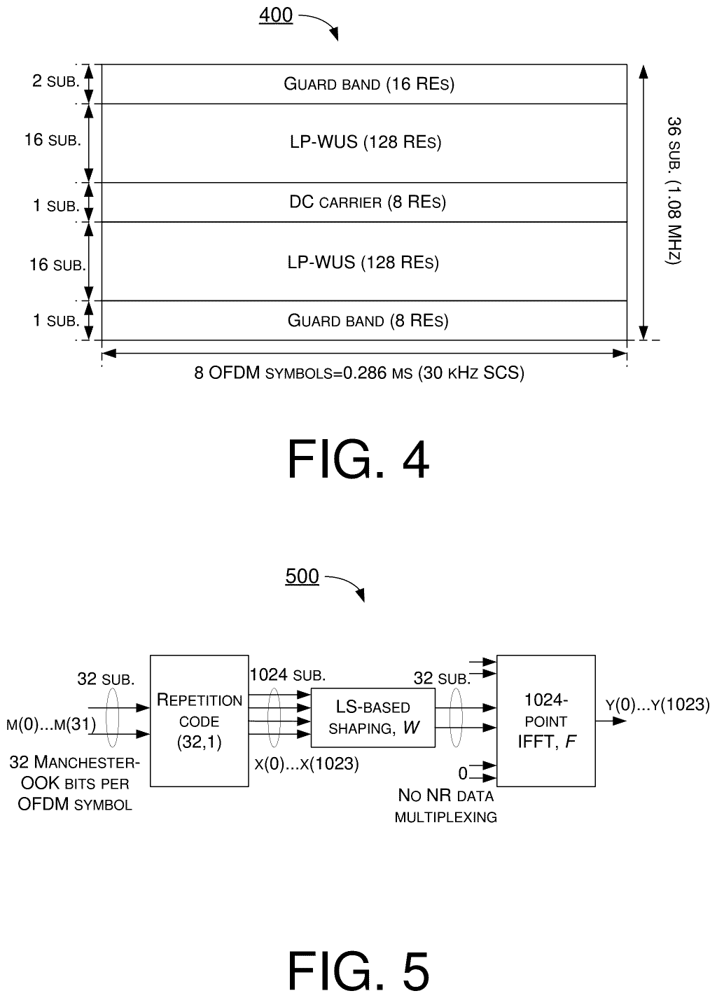

FIG. 4 illustrates an example scenario 400 for a RE mapping under schemes in accordance with implementations of the present disclosure. Scenario 400 involves a network node (e.g., a macro base station and multiple micro base stations) and a UE, which may be a part of a wireless communication network (e.g., an LTE network, a 5G/NR network, an IoT network or a 6G network). Referring to FIG. 4, in the 8 OFDM symbols, each coded LP-WUS sequence may be mapped into 128 REs, and each coded LP-WUS sequence may be configured between the DC carrier and the guard band.

The RE mapping information may be configured to the UE by the network node through the RRC or SIB. In an example, the UE may obtain the RE mapping information to prevent decoding the LP-WUS if the UE does not support the LP-WUS. In another example, the UE may use the RE mapping information to decode the LP-WUS if the UE supports the LP-WUS.

The center subcarrier (i.e., the DC subcarrier) may be not utilized when the WUR employs a DC blocker. The DC subcarrier may be typically excluded (e.g., LTE does not use the DC subcarrier) because it may suffer interference from local oscillator leakage.

The RE mapping may need zero padding to fill REs into several physical resource blocks (PRB). The zero padding bits can be reserved for the UE grouping or SFN information.

The guard band (GB) may be used to relax accuracy for an oscillator, and a bandpass filter (BPF) may be used in a LP-WUR. The guard band may comprise 2 RBs depending on the frequency error requirements.

The location of the DC carrier may be configured to the UE through the RRC or SIB. The main radio may share the DC location with the LP-WUR if the main radio has a voltage control oscillator (VCO) to change the central frequency. The configuration for enabling or not enabling the DC block may be configured to the UE through the RRC or SIB.

FIG. 5 illustrates an example scenario 500 for a waveform shaping under schemes in accordance with implementations of the present disclosure. Scenario 500 involves a network node (e.g., a macro base station and multiple micro base stations) and a UE, which may be a part of a wireless communication network (e.g., an LTE network, a 5G/NR network, an IoT network or a 6G network). Referring to FIG. 5, in the function module or circuit for the waveform shaping operation, the mapped REs of 32 Manchester-OOK symbols may be extended to 1024 symbols via a repletion code to reduce the data rate and lower the ADC requirements at the receiver (RX) of the UE. Then, the extended symbols may be passed to a linear shaping (LS)-based weighting matrix W to generate 32 symbols as the input of IFFT.

The LS-based shaping is given by W, where is the ideal WUS waveform on 24 REs and is the output waveform after 1024-point IFFT, and is a 1024×24 sub-matrix from a 1024×1024 IFFT matrix.

The repetition code may be used to control the data rate, e.g., 1 Manchester OOK bit duration. The repetition code may be configured to the UE through the RRC or SIB. The UE may report its capability to the network node to decode a given data rate.

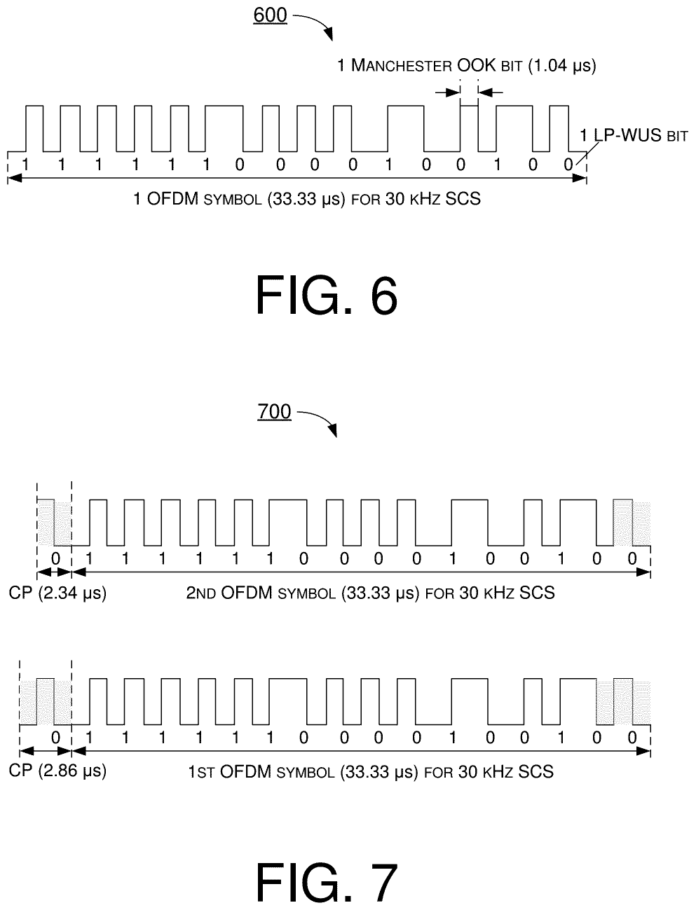

FIG. 6 illustrates an example scenario 600 for an OFDM symbol with Manchester OOK bits under schemes in accordance with implementations of the present disclosure. Scenario 600 involves a network node (e.g., a macro base station and multiple micro base stations) and a UE, which may be a part of a wireless communication network (e.g., an LTE network, a 5G/NR network, an IoT network or a 6G network). Referring to FIG. 6, in an OFDM symbol (33.33 microsecond (p)) for 30 kilohertz (kHz) subcarrier spacing (SCS), 1 Manchester OOK bit duration is 1.04 μs.

In some implementations, in the function module or circuit for the IFFT operation, the IFFT operation may be reused to the data (e.g., NR data) and the LP-WUS signal to generate the OOK waveforms. The IFFT operation may reduce the inter-symbol interference to the data, but the specific waveform distortion may exist for the OOK waveform. The information of indicating whether the network node uses IFFT to generate OOK waveform may be configured through the SIB or RRC. The LP-WUR may need IFFT information, such as IFFT size, to decode the LP-WUS.

In some implementations, in the function module or circuit for adding CP operation, each numerology may have two longer symbols (e.g., 5.21 μs is longer than 4.69 μs) within each 1 millisecond (ms) subframe, e.g., the first symbol and the fifteenth symbol within the 28 symbols for 30 kHz SCS. The SCS may be configured to the UE through the RRC or SIB. The LP-WUR may need the SCS information. The LP-WUR may need to know the final bit length of the Manchester-OOK bits due to the added CP. Alternatively, the network node may drop or truncate the Manchester OOK bits which are overlapped with the CP to keep the same bit length. The CP information may be configured to the UE through the RRC or SIB. The LP-WUR may know whether the CP is added or truncated and know the CP types based on the CP information.

FIG. 7 illustrates an example scenario 700 for a cyclic prefix (CP) adding under schemes in accordance with implementations of the present disclosure. Scenario 700 involves a network node (e.g., a macro base station and multiple micro base stations) and a UE, which may be a part of a wireless communication network (e.g., an LTE network, a 5G/NR network, an IoT network or a 6G network). Referring to FIG. 7, the CP length (2.86 μs) of the first OFDM symbol for the 30 kHz SCS may be longer than the CP length (2.34 μs) of the second OFDM symbol for the 30 kHz SCS.

The required timing information may be potentially provided by the main radio. For the 30 kHz SCS, the LP-WUS signal may start from the second OFDM symbol. If the total length is 8 OFDM symbols, the LP-WUS may be only added a short CP. The starting OFDM symbol may be configured to the UE through the RRC or SIB, and the CP location may be informed to UE for CP removal.

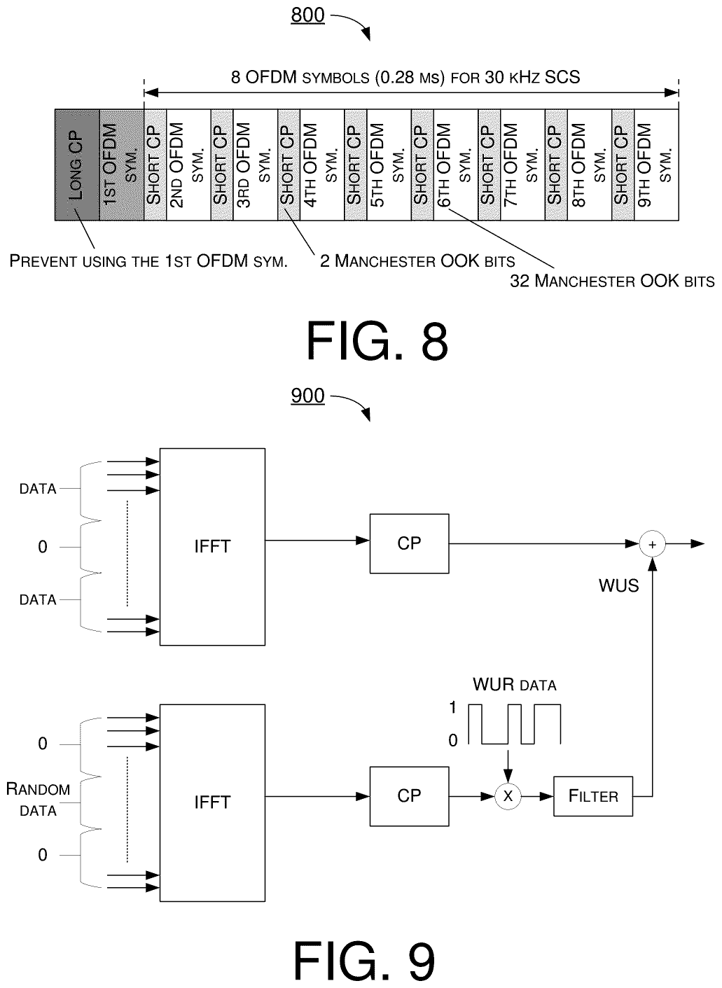

FIG. 8 illustrates an example scenario 800 for a CP configuration under schemes in accordance with implementations of the present disclosure. Scenario 800 involves a network node (e.g., a macro base station and multiple micro base stations) and a UE, which may be a part of a wireless communication network (e.g., an LTE network, a 5G/NR network, an IoT network or a 6G network). Referring to FIG. 8, if the total length (0.28 ms) for the LP-WUS is 8 OFDM symbols for the 30 kHz SCS, the first OFDM symbol may be added a long CP to prevent using the first OFDM symbol for the LP-WUS. The OFDM symbols for the LP-WUS may be added a short CP. The OFDM symbols for the LP-WUS may comprise 32 Manchester OOK bits, and the shot CP may comprise 2 Manchester OOK bits.

The guard time may exist between the OFDM symbols or the OOK symbols. The unit of the guard time may be μs or ms. The guard time may be configured to the UE through the RRC or SIB.

In some implementations, in the function module or circuit for the masking OOK operation, the OOK waveform may be generated by the modulation of the free band of subcarriers with the given OOK sequence. The free band of subcarriers may comprise random data drawn from some constellations, e.g., quadrature phase shift keying (QPSK). The remaining band of subcarriers may be allocated to other users.

The masking-based OOK may result in an inter-symbol interference and a potential peak-to-average power ratio (PAPR) impact. Therefore, a filter may be used as a waveform shaping after the OOK generation. The information for the masking OOK may be configured to the UE through the RRC or SIB. The LP-WUR may know whether the OOK is generated through the masking OOK or the discrete Fourier transform (DFT)-based waveform shaping based on the information. In addition, the LP-WUR may know whether the filter is enabled based on the information.

FIG. 9 illustrates an example scenario 900 for a masking OOK under schemes in accordance with implementations of the present disclosure. Scenario 900 involves a network node (e.g., a macro base station and multiple micro base stations) and a UE, which may be a part of a wireless communication network (e.g., an LTE network, a 5G/NR network, an IoT network or a 6G network). Referring to FIG. 9, the free band of subcarriers may comprise random data which may be modulated with the given OOK sequence. In addition, a filter may be used as a waveform shaping after the OOK generation.

In some implementations, the mixer may determine whether the LP-WUR can monitor the LP-WUS from different frequency bands. The quality of the mixer may impact the interference resilience and the support of the bandpass filter (BPF). In an example, the UE may report whether the LP-WUR can monitor more than on frequency bands. In another example, the LP-WUR may only monitor a default frequency band without a capability report. The default value for the capability support may be “not supported.”

In some implementations, the LPF may impact the interference resilience. The LPF with narrow bandwidth may achieve better interference suppression. The LPF with narrow bandwidth may take the good quality of the mixer. The UE may report its interference resilience level based on the LPF quality.

In some implementations, the ADC (e.g., N-bit ADC) may impact the receiver sensitivity and interference resilience. The ADC may need to determine a sampling rate as the signal bandwidth (BW). The UE may report the receiver sensitivity and the interference resilience and report whether the UE uses one-bit ADC. The sampling rate (or the LP-WUS BW) of the ADC sampling rate may be configured to the UE through the RRC or SIB. The LP-WUR should know the information about the ADC.

In some implementations, the ED may convert any input frequency to DC. The ED may be the bottleneck of the receiver sensitivity since it attenuates low-level input signals and adds excessive noise. Therefore, in some implementations, a DC blocker and an LPF may be configured follow the ED to filter out the DC component and the components at multiple of the carrier frequencies generated by the EP. The UE may report whether the LP-WUR uses a DC block or whether the LP-WUR can decode LP-WUS on the DC carrier.

In some implementations, a coherent or a non-coherent detector may be used to detect the LP-WUS preamble or payload. The cell-ID correlator (or sliding correlator) may be used with the buffered data to accommodate the time drift. If needed, the frequency steps may adjust the frequency drift. The cell ID, the partial cell ID, or the pre-determined preamble may be configured to the UE through the RRC or SIB. The LP-WUR should know the target sequence in the cell ID correlator.

In some implementations, the network node may broadcast or unicast the signals for the UE. The LP-WUS configuration may comprise the signals. The signals are discussed in the following different implementations. The UE may receive the signals and determine its behavior based on the signals. The UE may use the main radio to receive the signal through at least one of the RRC, SIB, MAC CE, and DCI format manners. The UE may use the LP-WUR to receive the signal via a wake-up channel. The wake-up channel may comprise the wake-up frames with one or multiple functionalities.

In some implementations, the UE may receive a plurality of WUR beacon frames transmitted by network node. The LP-WUR may use the WUR beacon frames to maintain timing synchronization to support the WUR duty cycle operation. The WUR beacon frames may comprise a transmitter ID or a cell ID.

In some implementations, the UE may receive a plurality of WUR wake-up frames transmitted by network node. The WUR wake-up frames may be used to notify one or more UEs that a network node has buffered data, critical update of system information, or a paging for the UE. The WUR wake-up frames may comprise at least one of a WUR ID, a WUR group ID, a transmitter ID, and a cell ID.

In some implementations, the UE may receive a plurality of short wake-up frames as a shortened version of the WUR wake-up frames.

In some implementations, the UE may receive a plurality of WUR discovery frames to support the discovery of network node or a cell by the LP-WUR at low power consumption. The WUR discovery frames may comprise at least one of a transmitter ID and a cell ID.

In some implementations, the UE may receive a plurality of WUR vendor specific frames to support vendor-specific operations.

In some implementations, the UE may receive a variable-length (VL) WUR frame to determine whether to wake up the main radio. The VL WUR frame may be configured to the UE through the RRC or SIB.

In some implementations, the UE may receive a WUR wake-up frame with a WUR group ID to determine whether to wake up the main radio. The ID may be configured to the UE through the RRC or SIB.

In some implementations, the UE may receive an individually addressed WUR wake-up frame and a broadcast WUR wake-up frame to determine whether to wake up the main radio.

In some implementations, the UE may report its WUR capabilities. The WUR capabilities may comprise the capabilities of discovery, synchronization, and wake-up instructions (scheduled or unscheduled).

In some implementations, the UE may report its transition delay. The transition delay may indicate the maximum time that the UE requires to transition from the doze state to the awake state.

In some implementations, the UE may report its WUR group IDs support. The WUR group IDs support may indicate the support for the 16 to 64 WUR group IDs.

In some implementations, the UE may report its WUR frequency division multiple access (FDMA) support. The WUR FDMA support may indicate whether the WUR FDMA channel switching capability is supported.

In some implementations, the UE may receive a plurality of go-to-sleep instructions (scheduled or unscheduled) to determine whether to power off the main radio or the LP-WUR.

In some implementations, the WUR service may allow the UE access to essential services provided by a cell while operating at very low power. The essential WUR services provided to the LP-WUR by the network may comprise at least one of discovery, synchronization, and wake-up instructions (scheduled or unscheduled).

In some implementations, in order to discover other cells, the UE may receive the WUS which comprises a searching time, cell IDs, or WUS IDs. The searching time may have a range or window in a unit of ms, and the searching time may be configured to the UE through the RRC or SIB.

In some implementations, the UE may receive an operation channel, a frequency band, or a resource, e.g., a physical resource block (PRB), a CORESET, a search space, to a monitor WUS.

In some implementations, the following parameters may be used to determine a WUR duty cycle operation. The parameters may comprise a start point, a WUR duty cycle service, a period, and a duty cycle period. In an example, a monitoring configuration from the network node may comprise an on-off switch of the LP-WUR corresponding to a WUR duty cycle.

The start point may indicate the start time of a WUR duty cycle service period.

In some implementations, the UE may receive the minimum wake-up duration which indicates the minimum WUR duty cycle service period of the WUR duty cycle operation in units of 256 μs. The minimum wake-up duration may be configured to the UE through the RRC or SIB.

In some implementations, the UE may receive the duty cycle period which may indicate the basic unit of the period of the WUR duty cycle operation in the unit of 4 μs. The duty cycle period may be configured to the UE through the RRC or SIB.

In some implementations, the UE may receive the WUR duty cycle start time that indicates the start of the duty cycle.

In some implementations, the UE may receive the WUR beacon period (e.g., always-on WUS for synchronization). The WUR beacon period may represent the number of time units between consecutive target WUR beacon transmission times. The WUR beacon period may be configured to the UE through the RRC or SIB.

In some implementations, the UE may receive the timing offset. The timing offset may indicate the time difference between the target WUR beacon transmission time and the target SSB transmission time. The timing offset may be configured to the UE through the RRC or SIB in a unit of ms.

In some implementations, the UE may receive the WUR channel offset. The WUR channel offset may indicate the offset of the WUR channel on which the WUR short wake-up frames, the WUR wake-up frames, or the WUR vendor specific frames may be transmitted relative to the WUR primary channel.

In some implementations, the UE may receive the counter that indicates the current counter included in the broadcast WUR wake-up frames which are transmitted by the network node.

In some implementations, the UE may receive a WUR ID that uniquely identifies the WUR within the cell.

In some implementations, the UE may receive the WUR frames with CRC code. The UE may decodes the WUR frames by a pre-defined CRC decoder, e.g., by the modulo 2 division of the calculation fields by the polynomial x16+x12+x5+1, where the shift register state is preset to all 1 s.

In some implementations, the LP-WUR may be in one of two power states. In the awake state, the LP-WUR may be fully powered. In the doze state, the LP-WUR may be not able to transmit or receive and the LP-WUR may consume very low power.

In some implementations, the LP-WUR may discard a WUR frame if the type of the WUR frame with a value that the WUR station (STA) does not support, or if any ID of the WUR frame with a value that the LP-WUR does not maintain.

In some implementations, a transmitter ID may be used to identify the WUR transmitter transmitting the WUR frame. Based on the LP-WUS configuration from the network node, the transmitter ID may be a bandwidth part (BWP) ID, a cell group ID, a frequency band ID, or a network node (e.g., gNB) ID. A WUR wake-up frame may be a broadcast WUR wake-up frame if the WUR wake-up frame has a transmitter ID. The broadcast WUR wake-up frame may be addressed to all the WUR UEs (i.e., the UE has LP-WUR).

In some implementations, the WUR group ID may be used to identify a group of one or more WUR UE. The WUR group ID may be selected from a WUR group ID space. A WUR wake-up frame with the WUR group ID may be defined as a group addressed WUR frame that is addressed to all the WUR UEs which can be identified by the WUR group ID.

In some implementations, the WUR ID may be used to identify a WUR UE which is the intended recipient of the WUR frame. A WUR frame with a WUR ID may be defined as an individually addressed WUR frame that is addressed to the WUR UE which can be identified by that WUR ID.

In some implementations, the WUR UE may receive the WUR beacon frames every 160 ms and receive the WUR Beacon frames within the WUR duty cycle service periods.

In some implementations, the UE may receive a WUR beacon frame and start a timer at the start of the first MC-OOK symbol containing the first bit of a given field. The timer may be used to control the duty cycle of the LP-WUR.

In some implementations, the WUR physical (PHY) (e.g., physical layer) may provide the support for data rates of 62.5 kb/s and 250 kb/s. The WUR low data rate (LDR) may be used to indicate the data rate of 62.5 kb/s, and the WUR high data rate (HDR) may be used to indicate the data rate of 250 kb/s. The WUR PHY may be configured through the RRC or SIB.

In some implementations, the WUR PHY may use the MC-OOK modulation for the WUR-synchronization (Sync) field and the WUR-data field. The MC-OOK may be defined as on-off keying modulation for a multicarrier signal.

In some implementations, the multicarrier signal may be generated using 13 contiguous subcarriers centered within a 20 MHz channel, with a subcarrier spacing of 312.5 kHz and with the center subcarrier being null. The subcarrier coefficients may take values from the BPSK, QPSK, 16-quadrature amplitude modulation (QAM), 64-QAM, or 256-QAM constellation symbols.

In some implementations, the duration or length of the WUR-Sync field may be either 64 μs or 128 μs. The length of the WUR-Sync field may be determined based on the rate of the WUR-data field.

In some implementations, for the WUR FDMA physical protocol data units (PPDUs) with 40 MHz and 80 MHz channel bandwidth, different WUR-Sync fields which are determined according to the rate of the WUR-data field may be applied to each 20 MHz sub-channel.

In some implementations, the structure of the WUR-Sync field may depend on the data rate of the WUR-data field. For the WUR LDR, the duration of the WUR-Sync field may be 128 μs. For WUR HDR, the duration of the WUR-Sync field may be 64 μs.

In some implementations, the receiver of the UE (or the OFDM-based MC-OOK system) may use the WUR-Sync field for the PPDU detection, symbol timing recovery, and data rate determination. For WUR LDR, the WUR-Sync field may be constructed as an MC-OOK signal. The WUR-Sync sequence may be constructed by concatenating two copies of the 32-bit sequence W, wherein each bit in the WUR-Sync sequence may be mapped to an MC-OOK symbol of duration 2 μs, and the 32-bit sequence W may be defined by W=[1 0 1 0 0 1 0 0 1 0 1 1 1 0 1 1 0 0 0 1 0 1 1 1 0 0 1 1 1 0 0 0].

In some implementations, for each input bit of the transmitted WUS, a ratio between the averaged power of the on-symbol of the transmit signal and the averaged power of the off-symbol of the transmit signal may be at least 20 dB.

In some implementations, the WUR PHY may measure the received signal strength and search for a valid WUR-Sync sequence to acquire the WUS to determine the WUR data rate and the start of the WUR-data field.

If the WUR PHY fails to detect the WUR-Sync sequence, the WUR PHY may return to the RX IDLE state.

If the WUR PHY detects a valid WUR-Sync sequence, the WUR PHY may begin receiving the MC-OOK symbols in the WUR-Data field.

If a signal loss occurs during the reception of the WUR PHY, the WUR PHY may discard any remaining bits which cannot be assembled into a complete octet.

If the WUR PHY is unaware of the end of the WUS, the WUS PHY may keep decoding until signal strength drops significantly.

On termination of the reception procedure of the WUR PHY, the WUR PHY may enter the RX IDLE state.

### Illustrative Implementations

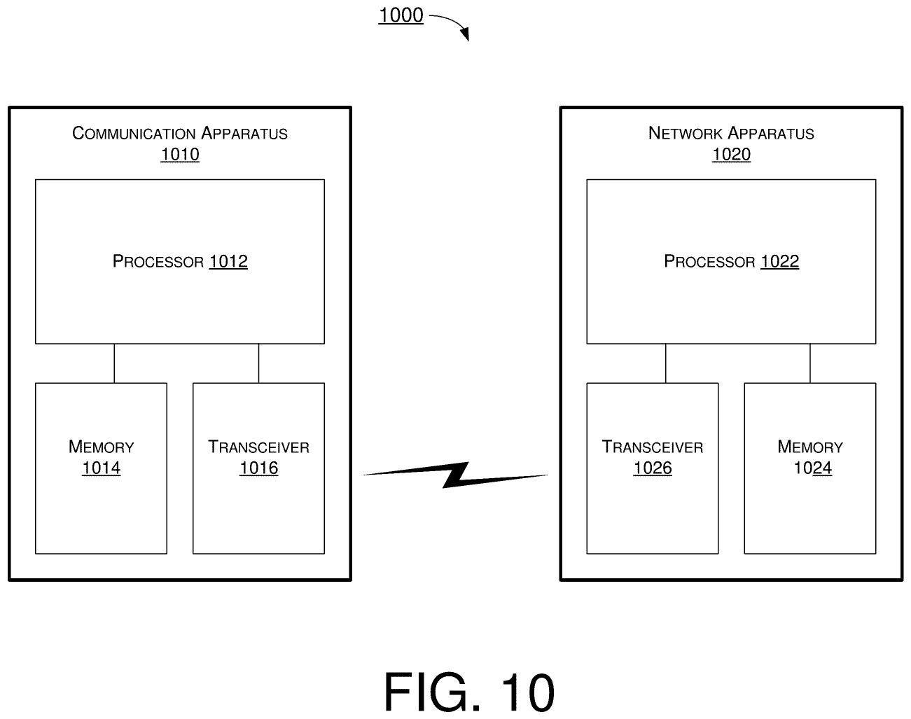

FIG. 10 illustrates an example communication system 1000 having at least an example communication apparatus 1010 and an example network apparatus 1020 in accordance with an implementation of the present disclosure. Each of communication apparatus 1010 and network apparatus 1020 may perform various functions to implement schemes, techniques, processes and methods described herein pertaining to the LP-WUS design in mobile communications, including the various schemes described above with respect to various proposed designs, concepts, schemes and methods described above and with respect to user equipment and network apparatus in mobile communications, including scenarios/schemes described above as well as process 1100 and process 1200 described below

Communication apparatus 1010 may be a part of an electronic apparatus, which may be a UE such as a portable or mobile apparatus, a wearable apparatus, a wireless communication apparatus or a computing apparatus. For instance, communication apparatus 1010 may be implemented in a smartphone, a smartwatch, a personal digital assistant, a digital camera, or a computing equipment such as a tablet computer, a laptop computer or a notebook computer. Communication apparatus 1010 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1010 may be implemented in a smart thermostat, a smart fridge, a smart door lock, a wireless speaker or a home control center. Alternatively, communication apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1010 may include at least some of those components shown in FIG. 10 such as a processor 1012, for example. Communication apparatus 1010 may further include one or more other components not pertinent to the proposed scheme of the present disclosure (e.g., internal power supply, display device and/or user interface device), and, thus, such component(s) of communication apparatus 1010 are neither shown in FIG. 10 nor described below in the interest of simplicity and brevity.

Network apparatus 1020 may be a part of a network apparatus, which may be a network node such as a satellite, a base station, a small cell, a router or a gateway. For instance, network apparatus 1020 may be implemented in an eNodeB in an LTE network, in a gNB in a 5G/NR, IoT, NB-IoT or IIoT network or in a satellite or base station in a 6G network. Alternatively, network apparatus 1020 may be implemented in the form of one or more IC chips such as, for example and without limitation, one or more single-core processors, one or more multi-core processors, or one or more RISC or CISC processors. Network apparatus 1020 may include at least some of those components shown in FIG. 10 such as a processor 1022, for example. Network apparatus 1020 may further include one or more other components not pertinent to the proposed scheme of the present disclosure (e.g., internal power supply, display device and/or user interface device), and, thus, such component(s) of network apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including autonomous reliability enhancements in a device (e.g., as represented by communication apparatus 1010) and a network (e.g., as represented by network apparatus 1020) in accordance with various implementations of the present disclosure.

In some implementations, communication apparatus 1010 may also include a transceiver 1016 coupled to processor 1012 and capable of wirelessly transmitting and receiving data. The transceiver 1016 may comprise a main radio and a LP-WUR. In some implementations, communication apparatus 1010 may further include a memory 1014 coupled to processor 1012 and capable of being accessed by processor 1012 and storing data therein. In some implementations, network apparatus 1020 may also include a transceiver 1026 coupled to processor 1022 and capable of wirelessly transmitting and receiving data. In some implementations, network apparatus 1020 may further include a memory 1024 coupled to processor 1022 and capable of being accessed by processor 1022 and storing data therein. Accordingly, communication apparatus 1010 and network apparatus 1020 may wirelessly communicate with each other via transceiver 1016 and transceiver 1026, respectively. To aid better understanding, the following description of the operations, functionalities and capabilities of each of communication apparatus 1010 and network apparatus 1020 is provided in the context of a mobile communication environment in which communication apparatus 1010 is implemented in or as a communication apparatus or a UE and network apparatus 1020 is implemented in or as a network node of a communication network.

In some implementations, processor 1012 may receive, via transceiver 1016, a LP-WUS configuration from network apparatus 1020. Processor 1012 may receive, via transceiver 1016 a LP-WUS based on the LP-WUS configuration from network apparatus 1020. Processor 1012 may determine whether to wake up according to the LP-WUS. The LP-WUS with N SCs may be generated through a transformation of M-bit OOK in a time domain. The transformation is a DFT or a least square operation. K samples are generated from the M bits with a signal modification and/or a signal truncation. In addition, the LP-WUS may be generated through an IFFT operation. The K is a size of the IFFT operation of CP-OFDMA. The N is less than or equal to the K.

In some implementations, a single-bit OOK is used in one OFDM symbol, and the N SCs of the LP-WUS are modulated based on a plurality of OOK values.

In some implementations, processor 1012 may determine the N SCs are modulated in an event that the OOK value corresponds to a first value (e.g., 1). Processor 1012 may determine that the N SCs are zero power in an event that the OOK value corresponds to a second value (e.g., 0).

In some implementations, the encoded bits may comprise at least one of a CRC code and a FCS code.

In some implementations, processor 1012 may perform an on-off switch of a LP-WUR of transceiver 1016 corresponding to a duty cycle according to a monitoring configuration for the LP-WUR in the LP-WUS configuration. Processor 1012 may perform a continuous monitoring according to the monitoring configuration for the LP-WUR in the LP-WUS configuration, wherein in the performing the continuous monitoring, the LP-WUR is on.

In some implementations, processor 1012 may obtain at least one of a UE group ID, a UE ID, a cell ID, a WUR ID and a WUR group ID. Processor 1012 may determine whether to apply the WUS configuration according to at least one of the UE group ID, the UE ID, the cell ID, the WUR ID and the WUR group ID.

In some implementations, processor 1022 may perform a transformation of M-bit on-off keying (OOK) in a time domain to generate a low-power wake-up signal (LP-WUS) with N subcarriers (SCs). The transformation is a discrete Fourier transform (DFT) or a least square operation. K samples are generated from the M bits with a signal modification and/or a signal truncation. Processor 1022 may perform an IFFT operation for the LP-WUS. The K is a size of the IFFT operation of CP-OFDMA. The N is less than or equal to the K. Processor 1022 may transmit, via transceiver 1026, an LP-WUS configuration to communication apparatus 1010. Processor 1022 may transmit, via transceiver 1026, the LP-WUS based on the WUS configuration to communication apparatus 1010.

In some implementations, a single-bit OOK is used in one OFDM symbol, and the N SCs of the LP-WUS are modulated based on a plurality of OOK values. In some implementations, in an event that the OOK value corresponds to a first value (e.g., 1), the N SCs may be modulated, and in an event that the OOK value corresponds to a second value (e.g., 0), the N may be zero power from a baseband point of view.

In some implementations, In some implementations, the LP-WUS may contain one or more sequences for detecting or selecting the LP-WUS, wherein the one or more sequences may be determined based on a sequence detection or a sequence selection, or based on the encoded bits, and wherein the one or more sequences may be associated with at least one of a configurable sequence type, an encoding scheme and additional bits.

In some implementations, the encoded bits may comprise at least one of a CRC code and a FCS code.

In some implementations, the LP-WUS configuration may comprises a monitoring configuration for a LP-WUR, and wherein the monitoring configuration may comprise an on-off switch of the LP-WUR corresponding to a duty cycle or a continuous monitoring in which the LP-WUR is on.

In some implementations, the LP-WUS may associate with at least one of a UE group ID, a UE ID, a cell ID, cell information, time information, SI change information, tracking area information, RAN information, SFN information, a WUR ID and a WUR group ID.

### Illustrative Processes

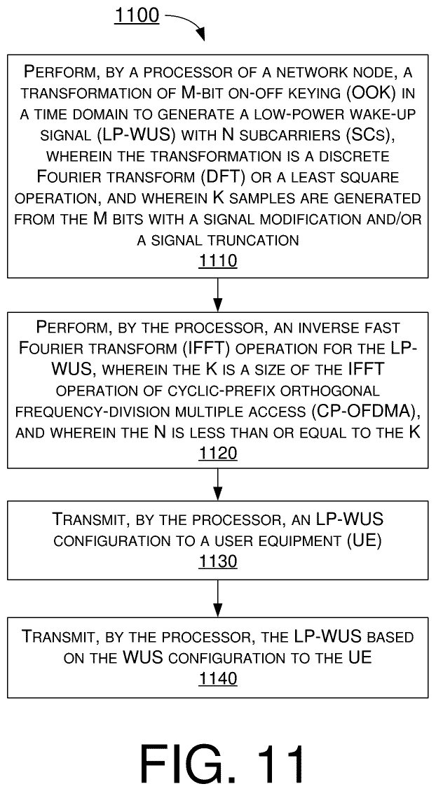

FIG. 11 illustrates an example process 1100 in accordance with an implementation of the present disclosure. Process 1100 may be an example implementation of above scenarios/schemes, whether partially or completely, with respect to the LP-WUS design with the present disclosure. Process 1100 may represent an aspect of implementation of features of network apparatus 1020. Process 1100 may include one or more operations, actions, or functions as illustrated by one or more of blocks 1110, 1120, 1130 and 1140. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by network apparatus 1120 or any base stations or network nodes. Solely for illustrative purposes and without limitation, process 1100 is described below in the context of network apparatus 1020. Process 1100 may begin at block 1110.

At 1110, process 1100 may involve processor 1022 of network apparatus 1020 performing a transformation of M-bit OOK in a time domain to generate a LP-WUS with N SCs, wherein the transformation is a DFT or a least square operation, and wherein K samples are generated from the M bits with a signal modification and/or a signal truncation. Process 1100 may proceed from 1110 to 1120.

At 1120, process 1100 may involve processor 1022 performing an IFFT operation for the LP-WUS, wherein the K is a size of the IFFT operation of CP-OFDMA, and wherein the N is less than or equal to the K. Process 1100 may proceed from 1120 to 1130.

At 1130, process 1100 may involve processor 1022 transmitting, via transceiver 1026, an LP-WUS configuration to a UE. Process 1100 may proceed from 1130 to 1140.

At 1140, process 1100 may involve processor 1022 transmitting, via transceiver 1026, the LP-WUS based on the WUS configuration to the UE.

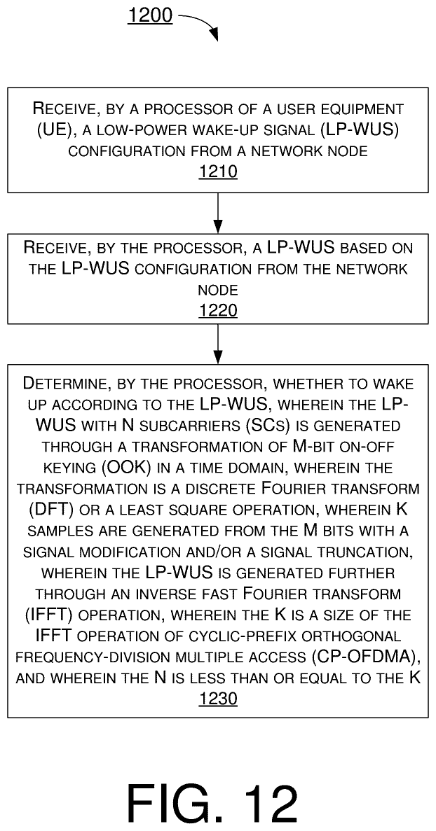

FIG. 12 illustrates an example process 1200 in accordance with an implementation of the present disclosure. Process 1200 may be an example implementation of above scenarios/schemes, whether partially or completely, with respect to the LP-WUS design with the present disclosure. Process 1200 may represent an aspect of implementation of features of communication apparatus 1010. Process 1200 may include one or more operations, actions, or functions as illustrated by one or more of blocks 1210, 1220 and 1230. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by communication apparatus 1010 or any suitable UE or machine type devices. Solely for illustrative purposes and without limitation, process 1200 is described below in the context of communication apparatus 1010. Process 1200 may begin at block 1210.

At 1210, process 1200 may involve processor 1012 of communication apparatus 1010 receiving, via transceiver 1016, a LP-WUS configuration from a network node. Process 1200 may proceed from 1210 to 1220.

At 1220, process 1200 may involve processor 1012 receiving, via transceiver 1016, a LP-WUS based on the LP-WUS configuration from the network node. Process 1100 may proceed from 1220 to 1230.

At 1230, process 1200 may involve processor 1012 determining whether to wake up according to the LP-WUS, wherein the LP-WUS with N SCs may be generated through a transformation of M-bit OOK in a time domain, wherein the transformation is a DFT or a least square operation, and wherein K samples are generated from the M bits with a signal modification and/or a signal truncation. In addition, the LP-WUS may be generated through an IFFT operation, wherein the K is a size of the IFFT operation of CP-OFDMA, and wherein the N is less than or equal to the K.

In some implementations, process 1200 may involve processor 1012 determining the N SCs are modulated in an event that the OOK value corresponds to a first value (e.g., 1), and determining that the N SCs are zero power in an event that the OOK modulation value to a second value (e.g., 0).

In some implementations, process 1200 may involve processor 1012 performing an on-off switch of a LP-WUR of transceiver 1016 corresponding to a duty cycle according to a monitoring configuration for the LP-WUR in the LP-WUS configuration, or performing a continuous monitoring according to the monitoring configuration for the LP-WUR in the LP-WUS configuration, wherein in the performing the continuous monitoring, the LP-WUR is on.

In some implementations, process 1200 may involve processor 1012 obtaining at least one of a UE group ID, a UE ID, a cell ID, a WUR ID and a WUR group ID, and determining whether to apply the WUS configuration according to at least one of the UE group ID, the UE ID, the cell ID, the WUR ID and the WUR group ID.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of a network node, a transformation of M-bit on-off keying (OOK) in a time domain to generate a low-power wake-up signal (LP-WUS) with N subcarriers (SCs), wherein the transformation is a discrete Fourier transform (DFT) or a least square operation, and wherein K samples are generated from the M bits with a signal modification or a signal truncation;
performing, by the processor, an inverse fast Fourier transform (IFFT) operation for the LP-WUS, wherein the K is a size of the IFFT operation of cyclic-prefix orthogonal frequency-division multiple access (CP-OFDMA), and wherein the N is less than or equal to the K;
transmitting, by the processor, an LP-WUS configuration to a user equipment (UE); and
transmitting, by the processor, the LP-WUS based on the WUS configuration to the UE.

2. The method of claim 1, wherein a single-bit OOK is used in one OFDM symbol, and wherein the N SCs of the LP-WUS are modulated based on a plurality of OOK values.

3. The method of claim 2, wherein in an event that the OOK value corresponds to a first value, the N SCs are modulated, and wherein in an event that the OOK value corresponds to a second value, the N SCs are zero power from a baseband point of view.

4. The method of claim 1, wherein the LP-WUS contains one or more sequences for detecting or selecting the LP-WUS, wherein the one or more sequences are determined based on a sequence detection or a sequence selection, or based on the encoded bits, and wherein the one or more sequences are associated with at least one of a configurable sequence type, an encoding scheme and additional bits.

5. The method of claim 1, wherein the encoded bits comprise at least one of a cyclic redundancy check (CRC) code and a frame check sequence (FCS) code.

6. The method of claim 1, wherein the LP-WUS configuration comprises a monitoring configuration for a low-power wake-up radio (LP-WUR), and wherein the monitoring configuration comprises an on-off switch of the LP-WUR corresponding to a duty cycle or a continuous monitoring in which the LP-WUR is on.

7. The method of claim 1, wherein the LP-WUS associates with at least one of a user equipment (UE) group identity (ID), a UE ID, a cell ID, cell information, time information, system information (SI) change information, tracking area information, radio access network (RAN) information, system frame number (SFN) information, a wake-up radio (WUR) ID and a WUR group ID.

8. An apparatus, comprising:
a transceiver which, during operation, wirelessly communicates with at least one user equipment (UE); and
a processor communicatively coupled to the transceiver such that, during operation, the processor performs operations comprising:
performing, by a processor of a network node, a transformation of M-bit on-off keying (OOK) in a time domain to generate a low-power wake-up signal (LP-WUS) with N subcarriers (SCs), wherein the transformation is a discrete Fourier transform (DFT) or a least square operation, and wherein K samples are generated from the M bits with a signal modification or a signal truncation;
performing an inverse fast Fourier transform (IFFT) operation for the LP-WUS, wherein the K is a size of the IFFT operation of cyclic-prefix orthogonal frequency-division multiple access (CP-OFDMA), and wherein the N is less than or equal to the K;
transmitting, via the transceiver, a LP-WUS configuration to the UE; and
transmitting, via the transceiver, the LP-WUS based on the WUS configuration to the UE.

9. The apparatus of claim 8, wherein a single-bit OOK is used in one OFDM symbol, and wherein the N SCs of the LP-WUS are modulated based on a plurality of OOK values.

10. The apparatus of claim 9, wherein in an event that the OOK value corresponds to a first value, the N SCs are modulated, and wherein in an event that the OOK value corresponds to a second value, the N SCs are zero power from a baseband point of view.

11. The apparatus of claim 8, wherein the LP-WUS contains one or more sequences for detecting or selecting the LP-WUS, wherein the one or more sequences are determined based on a sequence detection or a sequence selection, or based on encoded bits, and wherein the one or more sequences are associated with at least one of a configurable sequence type, an encoding scheme and additional bits.

12. The apparatus of claim 8, wherein the encoded bits comprise at least one of a cyclic redundancy check (CRC) code and a frame check sequence (FCS) code.

13. The apparatus of claim 8, wherein the LP-WUS configuration comprises a monitoring configuration for a low-power wake-up radio (LP-WUR), and wherein the monitoring configuration comprises an on-off switch of the LP-WUR corresponding to a duty cycle or a continuous monitoring in which the LP-WUR is on.

14. The apparatus of claim 8, wherein the LP-WUS associates with at least one of a user equipment (UE) group identity (ID), a UE ID, a cell ID, cell information, time information, system information (SI) change information, tracking area information, radio access network (RAN) information, system frame number (SFN) information, a wake-up radio (WUR) ID and a WUR group ID.

15. A method, comprising:
receiving, by a processor of a user equipment (UE), a low-power wake-up signal (LP-WUS) configuration from a network node;
receiving, by the processor, a LP-WUS based on the LP-WUS configuration from the network node; and
determining, by the processor, whether to wake up according to the LP-WUS,
wherein the LP-WUS with N subcarriers (SCs) is generated through a transformation of M-bit on-off keying (OOK) in a time domain, wherein the transformation is a discrete Fourier transform (DFT) or a least square operation, and wherein K samples are generated from the M bits with a signal modification or a signal truncation, and
wherein the LP-WUS is generated through an inverse fast Fourier transform (IFFT) operation, wherein the K is a size of the IFFT operation of cyclic-prefix orthogonal frequency-division multiple access (CP-OFDMA), and wherein the N is less than or equal to the K.

16. The method of claim 15, wherein a single-bit OOK is used in one OFDM symbol, and wherein the N SCs of the LP-WUS are modulated based on a plurality of OOK values.

17. The method of claim 16, further comprising:
determining, by the processor, that the N SCs are modulated in an event that the OOK value corresponds to a first value; and
determining, by the processor, that the N SCs are zero power from a baseband point of view in an event that the OOK value corresponds to a second value.

18. The method of claim 15, wherein the encoded bits comprise at least one of a cyclic redundancy check (CRC) code and a frame check sequence (FCS) code.

19. The method of claim 15, further comprising:
performing, by the processor, an on-off switch of a low-power wake-up radio (LP-WUR) corresponding to a duty cycle according to a monitoring configuration for the LP-WUR in the LP-WUS configuration; or
performing, by the processor, a continuous monitoring according to the monitoring configuration for the LP-WUR in the LP-WUS configuration, wherein the LP-WUR is on in performing the continuous monitoring.

20. The method of claim 15, further comprising:
obtaining, by the processor, at least one of a UE group identity (ID), a UE ID, a cell ID, a wake-up radio (WUR) ID and a WUR group ID; and
determining, by the processor, whether to apply the WUS configuration according to at least one of the UE group ID, the UE ID, the cell ID, the WUR ID and the WUR group ID.
